(19) United States
(12) Patent Application Publication
(10) Pub. No.: US 2013/0069405 A1
(43) Pub. Date: Mar. 21, 2013

(54) VEHICLE SEAT

(71) Applicants: Stefan Schehl, Dahn (DE); Joachim Kaemmerer, Kaiserslautern (DE)

(72) Inventors: Stefan Schehl, Dahn (DE); Joachim Kaemmerer, Kaiserslautern (DE)

(73) Assignee: KEIPER GMNH & CO KG, KAISERSLAUTERN (DE)

(21) Appl. No.: 13/579,438

(22) PCT Filed: Mar. 2, 2011
(86) PCT No.: PCT/EP11/01007

§ 371 Date: Dec. 10, 2012

(30) Foreign Application Priority Data
Apr. 1, 2010 (DE) 10 2010 014 058.9

(51) Int. Cl. B60N 2/02

(52) U.S. Cl. CPC B60N 2/02
USPC 297/313

(57) ABSTRACT

A vehicle seat has a base, a seat structure supporting a seat surface, and coupling elements allowing height adjusting and tilt adjusting of the seat surface relative to the base. Height is adjusted by a six-member seven-way linkage having six pivots, wherein angular orientation of two adjacent coupling elements relative to each other in a first linkage can be changed by a first fitting, and angular orientation of two adjacent coupling elements relative to each other is fixed at a second linkage by a second fitting. Angle adjustment is by the six-member seven-way linkage having six pivots, formed by the seven coupling elements. Angular orientation of two adjacent coupling elements relative to each other at the first linkage can be set via the first fitting, and angular orientation of two adjacent coupling elements relative to each other at the second linkage can be changed by the second fitting.

### BACKGROUND

The invention relates to a vehicle seat having the features of the preamble of claim 1.

A vehicle seat having adjustment for the inclination of the seat height and seat cushion is disclosed in DE 103 06 626 A1. Said vehicle seat is longitudinally adjustable. In this case, a plurality of arms which may be pivoted relative to one another and a sliding guide are provided, which permit the combined adjustment of the inclination of the seat height and seat cushion.

### SUMMARY

The object of the invention is to improve a vehicle seat of the aforementioned type. This object is achieved according to the invention by a vehicle seat having the features of claim 1. Advantageous embodiments form the subject-matter of the sub-claims.

By an arrangement according to the invention of a plurality of coupling elements, it is possible to integrate the adjustability of the inclination into the structure. For the adjustability, only two fittings have to be provided in the multi-articulated mechanism, wherein preferably one of the fittings is released for the height adjustment and the other fitting is released for the inclination adjustment, whilst in each case the other fitting is fixed. The multi-articulated mechanism is preferably exclusively locked via the two fittings, i.e. all of the other articulations are preferably configured without locking mechanisms. Naturally, however, for increasing the safety additional measures may be provided for locking individual articulations, but said measures are not required for the actual function of the vehicle seat which is adjustable in height/inclination.

In particular, the two fittings preferably have a common coupling element arranged on the opposing ends thereof. Said coupling element is particularly preferably the coupling element of the multi-articulated mechanism connected to the seat structure and thus the seat surface.

Preferably, two opposing coupling elements have a triangular structure, wherein an articulation is provided in each of the corner regions. The triangular structure is preferably configured in one piece, but a multi-part embodiment is also possible, for example by coupling rods fixedly connected together on the articulations.

Preferably at least one of the fittings, particularly preferably both fittings, is/are configured as a latching fitting. Alternatively, they may also be configured as rotary fittings or in the form of a simple locking mechanism which is locked in discrete positions using bolts or the like provided to this end.

### DRAWINGS

The invention is described in more detail hereinafter with reference to an exemplary embodiment shown in the drawings, in which:

FIG. 1 shows a schematic side view of the exemplary embodiment at a mean seat height with an approximately horizontal seat surface arrangement,

FIG. 2 shows a schematic side view of the vehicle seat of FIG. 1 at the lowest seat height with an approximately horizontal seat surface arrangement,

FIG. 3 shows a schematic side view of the vehicle seat of FIG. 1 at the greatest seat height with an approximately horizontal seat surface arrangement,

FIG. 4 shows a schematic side view of the vehicle seat of FIG. 1 at a mean seat height with the seat surface arrangement inclined to a maximum extent to the front,

FIG. 5 shows a schematic side view of the vehicle seat of FIG. 1 at a mean seat height with the seat surface arrangement inclined to a maximum extent to the rear, and

FIG. 6 shows a side view of the vehicle seat of FIG. 1.

### DETAILED DESCRIPTION

A vehicle seat 1 for a utility vehicle or a different motor vehicle is displaceably connected to rails (not shown) via a base 2 with a longitudinal adjuster 3 in the longitudinal direction of the seat. The vehicle seat 1 comprises a seat surface 5 which is adjustable in height and inclination, said seat surface comprising a seat structure 6 bearing a cushion and a backrest 7 which may be adjusted substantially independently of the seat inclination, said backrest comprising a backrest structure 8 bearing a cushion.

In the present case, the vehicle seat is configured substantially mirror-symmetrically relative to the central longitudinal plane, so that only one side is described in detail hereinafter. The transmission of movements, in particular adjusting movements, takes place via coupling elements arranged perpendicular to the central longitudinal plane, such as for example profiled transverse tubes.

The entire base 2 comprises a seven-member eight-way linkage with seven a, b, c, d, e, f, g rockers and with 8 articulations ab, bc, cd, de, ef, bg, fg, fa, wherein two of said articulations de, ef are able to be secured by fittings 10, 11. If the two fittings 10, 11 are locked, the system has no degree of freedom, i.e. the seat is fixed in position.

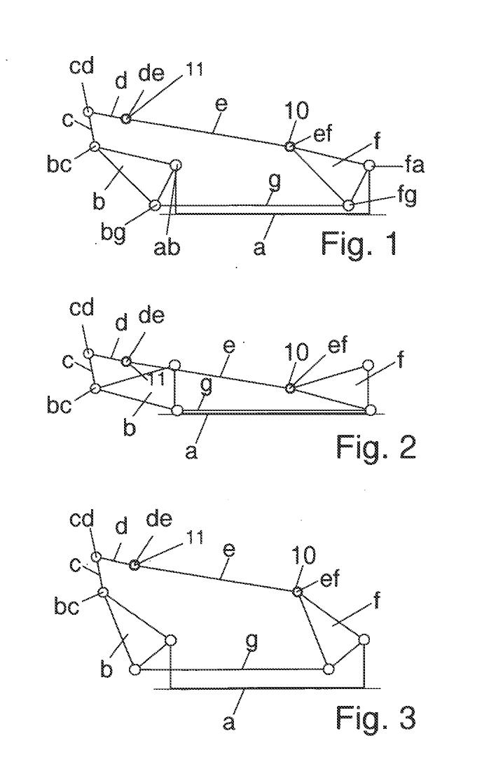

The height adjustment is described in more detail hereinafter with reference to FIGS. 1 to 3. The height adjustment takes place via a six-member seven-way linkage with six rockers which are formed by coupling elements a, b, c, d-e, f, g, wherein said coupling elements are connected together via seven articulations. For the height adjustment, the articulation de is blocked, so that the coupling elements d and e act as a single rocker, so that said six-member seven-way linkage is produced from the seven-member eight-way linkage.

In this case, the coupling element a which comprises the articulations ab and fa is displaceably arranged directly or via intermediate elements in the rails arranged on the vehicle floor, wherein the articulations ab and fa are arranged offset upwardly and due to their raised arrangement in combination with the seat structure 6 define the minimum seat height.

The second coupling element b which is connected in an articulated manner to the first coupling element a at the front articulation ab, said second coupling element serving as a rocker and being pivotable about the articulation ab, is connected in an articulated manner to the third coupling element c at a different end on the articulation bc. The coupling element c is connected at the articulation cd to a fourth coupling element d, which in turn is connected at the articulation de to a fifth coupling element e. For the height adjustment, however, said articulation de is fixed in the present case. The fifth coupling element e is connected to a sixth coupling element f via the articulation ef, wherein said articulation—corresponding to the articulation de—may be fixed. Moreover, a seventh coupling element g is provided between the coupling elements b and f, said seventh coupling element being attached in an articulated manner via the articulations bg and fg.

The second coupling element b, as visible from the figures, is configured to be triangular and has a further articulation bg with which it is connected in an articulated manner to the lower coupling element g, the function thereof being described in more detail below. The coupling element f arranged at the other end of the coupling element a also has a corresponding shape, said coupling element being connected via a further articulation fg to the opposing end of the coupling element g. Said coupling element g ensures that the coupling elements b and f move in a uniform manner. The seat surface 5 is not lowered when the fitting 10 is opened, as a spring pushes the seat frame upward.

For the fixing, a first fitting 10 is provided in the articulation ef and a second fitting 11 is provided in the articulation de. In the present case, both fittings are configured as latching fittings, as disclosed in DE 10 2006 015 560 B3, i.e. the angle between the adjacent coupling elements may be set and fixed, whereby all other angles are determined.

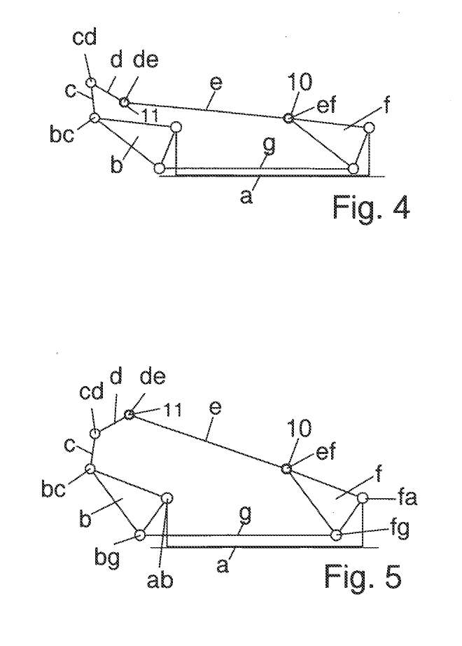

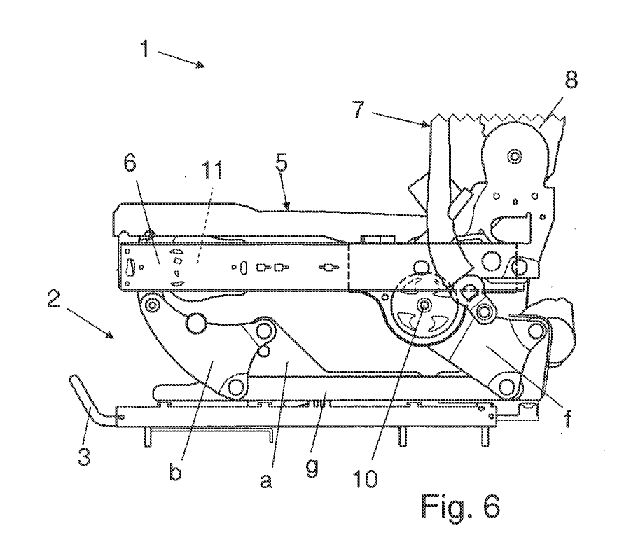

The inclination adjustment is described in more detail hereinafter with reference to FIGS. 4 and 5. The entire base 2 comprises, as disclosed above, a seven-member eight-way articulation with seven a, b, c, d, e, f, g rockers and with 8 articulations ab, bc, cd, de, ef, bg, fg, fa, wherein two of said articulations de, ef are able to be secured by fittings 10, 11. For adjusting the inclination, the first fitting 10 is fixed, i.e. the angle between the coupling elements e and f is constant when adjusting the inclination and the coupling elements e and f act as a single rocker, so that in turn a six-member seven-way linkage results, which however differs from the six-member seven-way linkage of the height adjustment.

The inclination is adjusted by an actuation of the fitting 11. By a reduction of the angle between the coupling elements d and e, starting from an extended angle (in the multi-articulated mechanism) of FIG. 4, the articulation de is raised, whereby the inclination of the coupling element e, on which the seat surface 5 is arranged, is altered relative to the coupling element a arranged in the present case parallel to the horizontal, so that in the present case the front seat edge is raised. Due to the fixed fitting 10, the angle between the coupling elements e and f remains unaltered. The coupling element f configured as a triangle is thus also altered in its inclination. The movement is transmitted in the articulation fg to the additional coupling element g and thus to the opposing triangular coupling element b (articulation bg), i.e. the respective pivoting movements of the two triangular coupling elements b and f correspond to one another. The articulation bc is raised in accordance with the articulation ef, and the short coupling element c pivots, adapting to the movement of the coupling element d fixed to the fitting, to which it is connected via the articulation cd.

The schematic drawing shows coupling elements a and g of the same length and two coupling elements b and f corresponding to one another in the arrangement of the articulations thereof, which permits a decoupling of the height and inclination adjustment.

If, however, the coupling elements a and g are of different length and/or the coupling elements b and f differ in the arrangement of the articulations thereof, this results in a superimposition of the height and inclination adjustment.

As an alternative to the above description, the fitting 10 may also be provided in one of the following articulations: ab, fa, fg, bg, bc. The arrangement in the articulation of is, however, advantageous as in this case the fitting 10 may be fastened to the seat frame.

As an alternative to the above description, the fitting 11 may also be arranged in the articulation cd, but the arrangement in the articulation de is advantageous as in this case the fitting 11 may be fastened to the seat frame.

The fitting 10 may, as described, be a latching fitting, but alternatively a rotary fitting or any other locking mechanism is also possible. In the case of the fitting 11, a latching fitting is preferably provided, as described above, but alternatively a rotary fitting may also be provided.

### List of Reference Symbols

1 Vehicle seat
2 Base
3 Longitudinal adjuster
5 Seat surface
6 Seat structure
7 Backrest
8 Backrest structure
10 Fitting (height adjustment)
11 Fitting (inclination adjustment)
a, b, c, d, e, f, g Coupling element
ab, bc, cd, de, ef, bg, fg, fa Articulation

1. A vehicle seat, in particular a utility vehicle seat, comprising a base, a seat structure bearing a seat surface or forming the seat surface, and a plurality of coupling elements which permit an adjustability of the height and inclination of the seat surface relative to the base, wherein
the height is adjusted via a six-member seven-way linkage with six rockers which are formed by seven coupling elements, wherein a first two adjacent coupling elements in a first articulation are able to be altered in their angular position relative to one another via a first fitting and a second two adjacent coupling elements are fixed in their angular position relative to one another by a second fitting in a second articulation, and
the inclination is adjusted via the six-member seven-way linkage with six rockers which are formed by the seven coupling elements, wherein the first two adjacent coupling elements in the first articulation are fixed in their angular position relative to one another via the first fitting, and the second two adjacent coupling elements in the second articulation are able to be altered in their angular position relative to one another by the second fitting.

2. The vehicle seat as claimed in claim 1, wherein first and last coupling elements are arranged in parallel in terms of their movement.

3. The vehicle seat as claimed in claim 1, second and fifth coupling elements are connected via in each case a further articulation which is arranged spaced apart from an articulation connected to the first coupling element with a further common coupling element, so that the first and last two coupling elements are coupled in their relative movements.

4. The vehicle seat as claimed claim 1, wherein the two fittings have a common coupling element arranged on the opposing ends thereof.

5. The vehicle seat as claimed in claim 1, wherein two opposing coupling elements have a triangular structure, and wherein wherein an articulation is provided in each of of a plurality of corner regions.

6. The vehicle seat as claimed in claim 1, wherein at least one of the fittings is arranged on the seat structure and one of the coupling elements is connected fixedly to the seat structure.

7. The vehicle seat as claimed in claim 6, wherein the two fittings are arranged on the seat structure.

8. The vehicle seat as claimed in claim 1, wherein all articulations of the height and inclination adjustment comprise parallel pivot axes.

9. The vehicle seat as claimed in claim 1, wherein at least one of the fittings is a latching fitting.

10. The vehicle seat as claimed in claim 9, wherein both fittings are latching fittings.
